(19) United States
(12) Patent Application Publication
(10) Pub. No.: US 2025/0222503 A1
(43) Pub. Date: Jul. 10, 2025

(54) SOLID STATE MANUFACTURING TOOLS AND METHODS OF USING THEM

(71) Applicant: MELD MANUFACTURING CORPORATION, Christiansburg, VA (US)

(72) Inventors: Timothy Bell, Christiansburg, VA (US); Chase Cox, Christiansburg, VA (US)

(21) Appl. No.: 18/921,431

(22) Filed: Oct. 21, 2024

Related U.S. Application Data
(60) Provisional application No. 63/545,105, filed on Oct. 20, 2023.

(51) Int. Cl. B21C 23/04; B33Y 10/00; B33Y 30/00

(52) U.S. Cl. CPC B21C 23/04; B33Y 10/00; B33Y 30/00

(57) ABSTRACT

Certain configurations of a solid state manufacturing tool comprising one or more internal passageways configured to cool the solid state manufacturing tool during use of the tool are described. Solid state manufacturing systems that use the tool in combination with other components to add solid material to a surface are also described.

### PRIORITY APPLICATION

This application is related to and claims priority to and the benefit of U.S. Provisional Application No. 63/545,105 filed on Oct. 20, 2023, the entire disclosure of which is hereby incorporated herein by reference for all purposes.

### TECHNOLOGICAL FIELD

Certain embodiments described herein are directed to tools that can be used in solid state manufacturing systems and/or processes. More particularly, certain configurations described are directed to tools that can include one or more internal passageways.

### BACKGROUND

Metal parts are often produced using forging or extrusion processes. Forging and extrusion processes often require the use of expensive components to shape or produce the metal parts. These parts can experience significant heat during production which may alter the overall properties of the produced metal parts and can reduce the usable lifetime of the components used in the production processes.

### SUMMARY

Certain aspects, embodiments, features and attributes of solid state manufacturing tools are described. The tools can include one or more internal passageways configured to cool the solid state manufacturing tool during use. The internal passageways can include complex and/or non-linear geometries to facilitate heat control during use of the tool. Large and complex parts can be produced using the tool.

In an aspect, a solid state manufacturing tool comprises one or more internal passageways configured to cool the solid state manufacturing tool during use. In certain embodiments, another aspect, the tool comprises a 1-piece or unitary body.

In other embodiments, the tool comprises one or more heat exchange structures. In some configurations, the heat exchange structures are internal heat exchange fins. In other configurations, the heat exchange structures are external heat exchange fins. In some instances, the heat exchange structures include both internal heat exchange fins and external heat exchange fins.

In certain embodiments, a tool body of the tool comprises tool steel, copper, a copper alloy, tungsten or a tungsten alloy. If desired, the internal passageways can be coated with materials which are different than those used to produce the tool body.

In some configurations, at least one internal passageway comprises a non-linear shape. In other embodiments, at least one internal passageway is arranged in a non-longitudinal manner relative to a longitudinal direction of the tool body. For example, in some instances at least one internal passageway is arranged radially.

In another aspect, an additive manufacturing system comprises a feeding unit configured to receive a filler material, a spindle comprising an internal path configured to receive the filler material, e.g., a solid filler material, from the feeding unit, a tool coupled to the spindle and configured to receive the filler material from the spindle and add the received filler material to a surface of a substrate in a solid state, wherein the tool comprises the solid state manufacturing tool as described herein. The system also comprises a temperature sensor configured to measure a temperature of the tool during addition of the filler material to the surface of the workpiece, a processor electrically coupled to the temperature sensor and the spindle, and a computer readable medium electrically coupled to the processor, wherein the computer readable medium has instructions stored thereon, wherein the instructions, when executed by the processor, cause the processor to control movement of the spindle during addition of the filler material to the surface of the substrate.

In certain embodiments, the processor is configured to increase a temperature of the tool from a first tool temperature to a second tool temperature that is the same as or greater than the first tool temperature. The exact tool temperature can vary from about 350 degrees Celsius up to 1500 degrees Celsius depending on the materials and additive processes being used. In some embodiments, the tool comprises tool steel, copper, a copper alloy, tungsten or a tungsten alloy. In other embodiments, the tool comprises at least one nub. In additional embodiments, the feeding unit comprises an actuator to force the filler material into the spindle and the tool.

In another aspect, a subtractive and additive method comprises adding a solid material as a first layer to a surface of a substrate using an additive manufacturing process comprising the tool as described herein, wherein the solid material is added to the surface of the workpiece in a solid state at a first tool temperature, and removing a portion of the added solid layer using a subtractive process to provide a subtracted, first solid layer on the substrate.

In certain embodiments, a first tool temperature of the tool is at least 350 degrees Celsius. In some embodiments, the method comprises adding a second solid layer in the solid state to the subtracted, first solid layer using the tool, wherein the second solid layer is added using a second tool temperature that is the same as the first tool temperature. In certain configurations, the method comprises adding a second solid layer in the solid state to the subtracted, first solid layer using the tool, wherein the second solid layer is added using a second tool temperature that is greater than the first tool temperature.

In some embodiments, the first tool temperature is maintained using the internal passageways of the tool and by one or more of varying a speed of a spindle coupled to the tool; or varying torque of the spindle coupled to the tool; or varying power of the spindle coupled to the tool; or varying a deposition rate of the added solid material; or varying a traverse rate of the tool; or varying a filler feed rate into the tool; or varying a layer height; or varying a filler force; or varying a pressure under the tool; or using an external heating/cooling source adjacent to the tool; or using an external heating/cooling source adjacent to the surface of the substrate; or varying a tool geometry during addition.

Additional aspects, embodiments, features and configurations are described in more detail below

### BRIEF DESCRIPTION OF THE SEVERAL VIEWS OF THE DRAWINGS

Certain configurations are described with reference to the accompanying drawings in which:

FIG. 1 is an illustration of certain components of a solid state additive manufacturing system including a feeding unit, a spindle and a tool, in accordance with certain embodiments;

FIG. 2 is an illustration showing a feeding unit, a spindle, a tool and certain other components of a solid state additive manufacturing system, in accordance with certain embodiments;

FIG. 3 is another illustration showing a feeding unit, a spindle, a tool and certain other components of a solid state additive manufacturing system, in accordance with certain embodiments;

FIG. 4 is an additional illustration showing a feeding unit, a spindle, a tool and certain other components of a solid state additive manufacturing system, in accordance with certain embodiments;

FIG. 5 is an illustration showing a tool including surface features, in accordance with certain embodiments;

FIG. 6 is an illustration showing a temperature sensor positioned within or adjacent to a tool, in accordance with certain embodiments;

FIG. 7 is an illustration showing various components of a control system including a processor that can be used to control operation of the various components in a solid state additive manufacturing system;

FIG. 8 is an illustration showing a combined additive manufacturing system and a subtractive system, in accordance with certain embodiments;

FIG. 9 is an illustration of a tool, in accordance with certain embodiments;

FIG. 10 and FIG. 11 are illustrations of a tool comprising different diameters at different ends, in accordance with certain embodiments; and

FIG. 12, FIG. 13, FIG. 14, FIG. 15, FIG. 16 and FIG. 17 are illustrations of a tool showing various internal passageways, in accordance with certain embodiments.

It will be recognized by the person of ordinary skill in the art that the internal passageways shown in the figures are not necessarily shown to scale and various cross-sectional geometries and dimensions can be present as desired.

### DETAILED DESCRIPTION

Certain embodiments are described of tooling which can be used in solid state manufacturing methods and systems. In some embodiments, the tooling can be used in two or three dimensional additive friction stir deposition systems and processes. As noted in more detail below, the tooling can include one or more of integrated cooling, temperature sensing and be configured to receive and/or provide a shield gas. The presence of integrated cooling can provide several attributes including, but not limited to, longer tool life and improved reliability.

In some configurations, engineered cooling passages can be present inside the tool to achieve a more controlled cooling method. If desired internal passages for transferring inert shield gas to the tool/work interface can be present either alone or along with internal cooling passages. In some embodiments, the tool can be used without any external cooling air or an external cooling jacket. In other embodiments, the tool with internal passageways can be used in combination with external cooling air or an external cooling jacket.

The exact internal passageway design shape and/or geometry can vary depending on the desired cooling, the metal to be deposited, and various other system parameters described in more detail below. If desired, a cooled fluid, e.g., cooled air or a cooled liquid, can be introduced into the internal passageways to facilitate removal of heat from the tool or to control the temperature of the tool. In other instances, a heated fluid can be introduced into the tool to increase tool temperature prior to or during addition of material to the surface.

In certain embodiments, the tool may be a unitary or 1-piece tool and not include a separate print head or separate components. The internal passageways can be machined or otherwise produced within the unitary tool. If desired, the tool can include internal and/or external heat exchange structures, e.g., fins, coils, chevrons, etc., facilitate heat transfer out of the tool and to the ambient environment. The heat exchange structures can take various shapes and geometries including “tree branch” shapes, linear shapes, non-linear shapes and complex shapes. If desired, the heat exchange structures themselves can include internal passageways that can receive a fluid such as a gas or liquid. In some instances, internal heat exchange structures, e.g., fins, may be thermally coupled to external heat exchange structures, e.g., external fins, to facilitate movement of heat away from the inner surfaces of the tool and toward exterior surfaces of the tool. The arrangement of heat exchange structures may be asymmetric so more heat exchange structures are closer to hotter areas of the tool and fewer heat exchange structures are present away from the hotter surfaces. For example, at the interface between the tooling and a substrate that receives the material to be printed/added, more heat exchange structures may be present to better remove heat and/or control the temperature at those areas. Fewer or no heat exchange structures may be present toward a top surface of the tool that receives an input of feedstock material.

The exact material used with the tooling may vary and includes metals (e.g., aluminum, titanium, aluminum alloys, titanium alloys, aluminum lithium alloys, copper, copper alloys), non-metals, metalloids, polymers, plastics and combinations thereof. In general and as noted in more detail below, the material is added in a solid state using the tool.

In some arrangements, the tool can be configured to receive non-lubricated solid materials through internal feedstock channels, which are different and separate from the internal cooling passageways and any shielding gas passageways.

### SSA System Components

In some examples, the SSA manufacturing system may use a friction stir additive process to build parts using a solid-state method that can produce large three-dimensional shapes without melting and resolidifying the metal and without expensive tooling. Compared to casting, the properties and metal integrity (density, constituent particles, voids) are much better for the SSA manufacturing process. Unlike forging, no expensive tooling is required which not only saves money, but also reduces lead time to produce parts. Compared to machined plate, much thicker parts can be produced as plate is limited to approximate 200 mm high walls and even that uses 200 mm thick plate which has significantly reduced strength because of the slow quench for thick products. The SSA manufacturing process allows the parts to be tailored and designed in ways that are not possible for forgings because there are few limitations on geometry. For example, walls become closer together as they are deposited making shapes like enclosed cones possible. The resulting articles can have similar properties as plates and forgings.

In certain configurations, the exact process steps used in SSA manufacturing can vary as noted in detail below. In general and without intended to limit the particular process steps and conditions that can be used, the manufacturing process starts with a substrate, usually plate, but can be other product forms such as extrusions and forgings, then involves layer-by-layer building of parts in either single walls for thinner sections, or multiple, overlapping walls for thicker sections. By moving the depositing spindle relative to a reference point, the 3D parts are built up with selected geometries. The process controls deposition within careful parameters including external heat/cooling, deposition rate, rotational frequency, and spindle travel while monitoring temperature and using temperature feedback to affect the other parameters to achieve excellent adhesion and metallurgical bonding between each layer and overlap. The material that is added to the substrate in solid form is typically non-heat treated alloy which can then be heat treated/aged post-deposition to provide a desired temper. The material can be removed from the substrate post-deposition, or the substrate may remain in contact with the added material and used to form the final part.

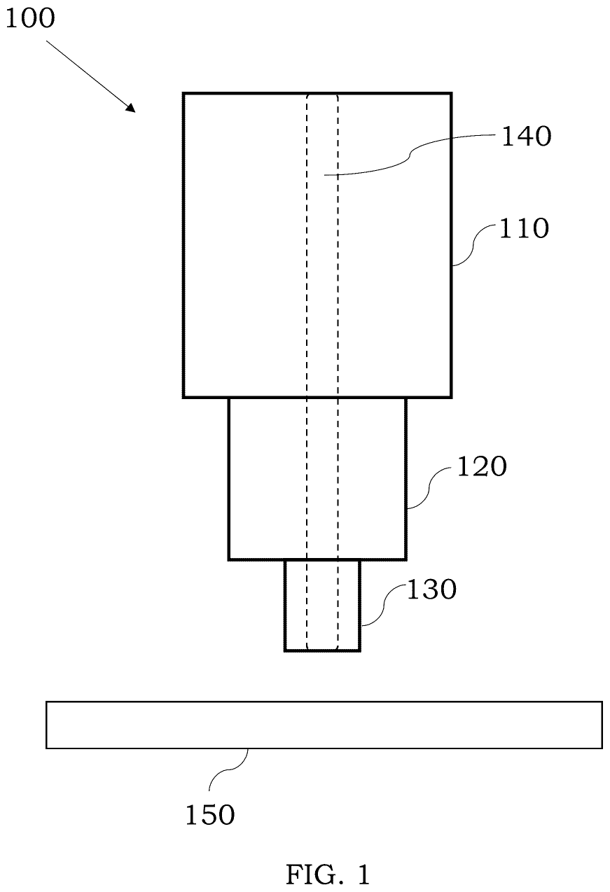

In certain embodiments, a schematic of various components of a solid state additive manufacturing system is shown in FIG. 1. The system 100 includes a feeding unit 110, spindle 120, and a tool 130. A passageway (throat) for the feedstock material material (feedstock) 140 is shown. The system 100 can include other components as noted below. A substrate 150 is shown that receives the printed feedstock material from the tool 130. While not shown, a cooling fluid can be fluidically coupled to the tool 130 to introduce the cooling fluid into the tool 130 to remove heat and/or control temperature of the tool 130. Alternatively, the tool 130 may be cooled using internal passageways (as described below) and without using any introduced cooling fluid in the tool. The feedstock material can be fed into the throat 140 from the feeding unit 110 at a desired rate as noted below. For example, a piston or rod can be used to push the feedstock material toward a surface of the substrate 150. The spindle 120 is generally coupled to a motor (not shown) to rotate the spindle 120 and tool 130 at a desired rotational speed. The tool 130 is placed adjacent to the substrate 150 and deposits the feedstock material in the throat onto the surface of the substrate 150 in solid form. As noted in more detail below, the tool 130 can include surface features and/or certain geometries to assist in deposition of the feedstock material onto the surface of the substrate 150. Friction-based fabrication tool 130, which can include internal passageways as noted herein, generally comprises a non-consumable body formed from material capable of resisting deformation when subjected to frictional heating and compressive loading at the surface of the substrate 150. As the spindle 120 and tool 130 rotate, a thin layer or track of the feedstock material is deposited onto the surface of the substrate 150. The deposition temperature can be tightly controlled to impart a desired microstructure, and correspondingly provide desired deposited feedstock material properties, to the deposited material after heat treatment. The deposition temperature may be lower during initial deposition of feedstock material onto the substrate 150 and can be increased during addition of successive layers/walls/tracks to provide a desired metallurgical bond between the multiple walls/layers/tracks. The exact temperature difference can vary depending on the particular alloy that is used, and illustrative deposition temperatures are described in more detail below.

In certain embodiments, the system 100 can include suitable platforms, motors or other components to permit the substrate 150 to move independently of the spindle 120 and the tooling 130. For example, each of the substrate 150 and the tooling 130 can independently be moved in x-, y-, and z-directions. This independent movement provides for production of complex geometric shapes, varying thicknesses across the surface of the produced part and permits for enhanced control of the various components during deposition of the feedstock material onto a surface of the substrate 150.

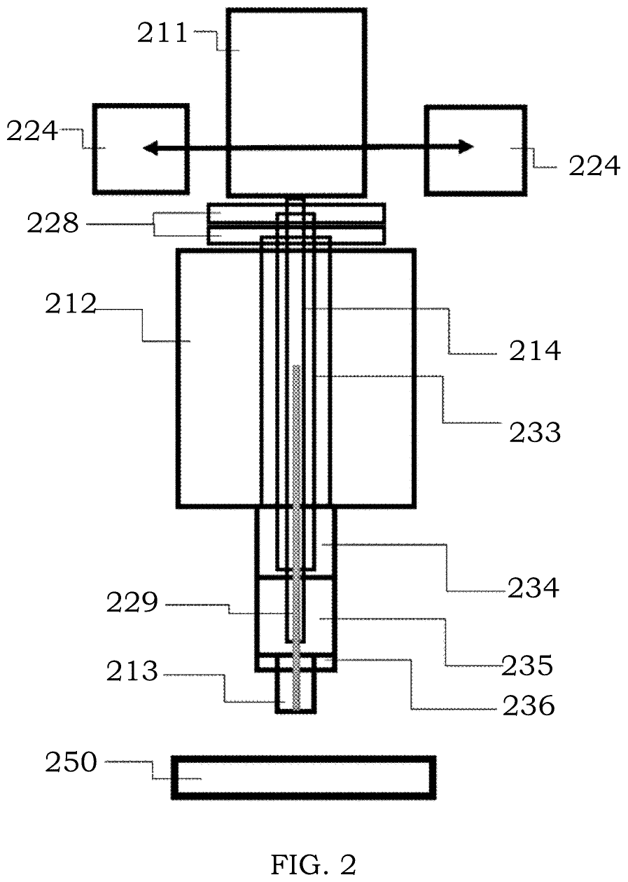

In certain configurations, the feeding unit of the system 100 generally comprises a reservoir configured to receive the feedstock material. The exact shape and configuration of the reservoir may vary depending on the particular form of the feedstock material to be used. The feedstock material can be fed in a continuous or non-continuous manner as desired. An illustration of certain components of a feeding unit configured to feed continuous solid rod or solid rod-like feedstock material is shown in FIG. 2. The feeding unit 211 is shown being placed in communication with a spindle 212 and a tool 213. A throat or operational passageway 214 is shown along with a substrate 250 that can receive the feedstock material material. Other system components, such as the motors 224, drive pulleys 228 for spindle 212, rod filler material 229, secondary spindle, which is floating (non-driven) 233, lower spindle 234, tool holder 235 and a pressure plate 236 are shown as well.

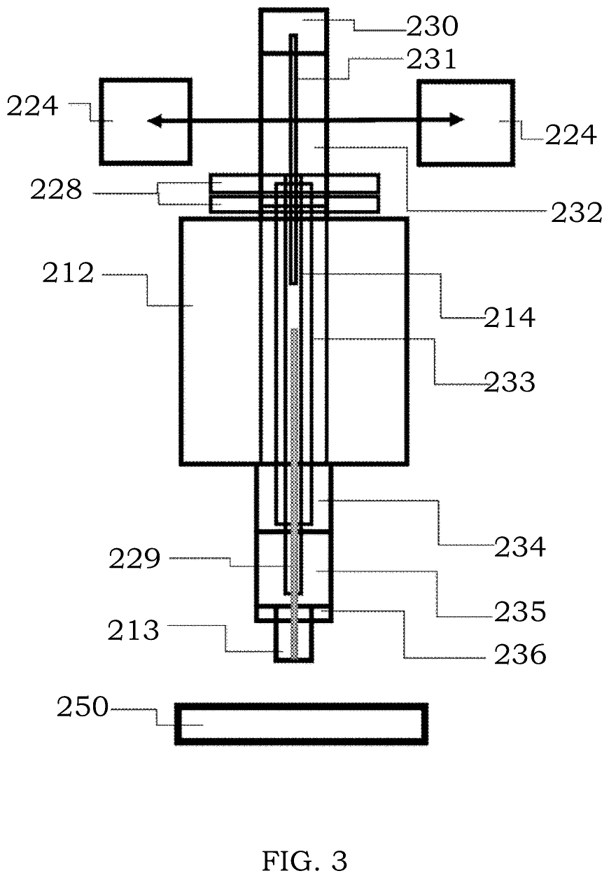

Another illustration of a feeding unit is shown in FIG. 3. This feeding unit shown in FIG. 3 can be used to feed discontinuous solid feedstock material material, which can be in the form of rods, squares or other shapes. The illustration in FIG. 3 shows the spindle 212 and the tool 223 with operational passageway 204 and the workpiece 250. Other system components, such as the motors 224, drive pulleys 218 for spindle 212, rod filler material 229, actuator-downward force driver 230, push rod 231, solid feed push-rod and actuator stand with bearings 232, secondary spindle, which is floating (non-driven) 233, lower spindle 234, tool holder 235 and a pressure plate 236. In certain embodiments, the feeding unit can include and use an actuator 230, a push rod 231, two guide rods and cross member, wherein the actuator creates a downwards force to push the feedstock material through the throat 214 and onto the substrate. The guide rods and cross member are optional and can be present for stabilizing the push rod 231.

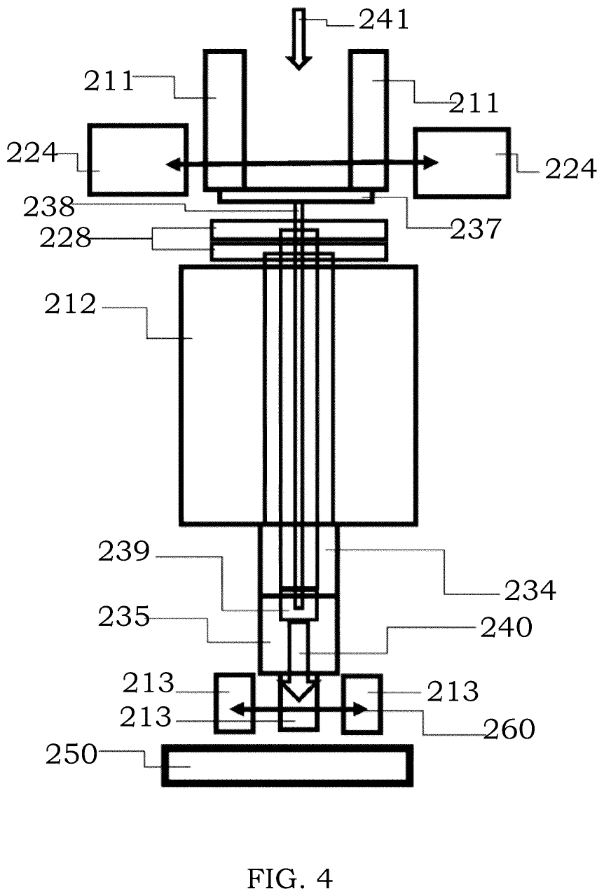

Another illustration of a feeding unit is shown in FIG. 4. This feeding unit shown in FIG. 4 can be used to feed powder, particle or pellet type feedstock material material. Shown in cross-section in FIG. 4 are a feeding unit 211, spindle 212 and tools 213 with operational passageway 214 and a substrate 250 that can receive the powder-or pellet-like filler feedstock material from the tool 213. Other system components, such as the motors 224, drive pulleys 228 for the spindle 212, secondary spindle, which is floating (non-driven) 233, lower spindle 234, tool holder 235, pressure plate 236, lateral delivery system 237, mixing downtube 238, auger drive mechanism 239, auger assembly 240 and optional injection ports for liquid additives (e.g. lubricants, catalysts, etc.) 241 are shown. A tool changer 260 is also shown and discussed in more detail below.

While the illustrative feeding units shown in FIGS. 2-4 are configured to provide different types of feedstock material material to an underlying substrate, combinations of different feedstock material can also be present in a feeding unit and provided to the tooling for deposition on a substrate. The tool holder 235 with throat is capable to hold and rotate the tool, and the throat allows feedstock material to be provided from the feeding unit to the substrate.

In certain embodiments, a tool changer 260 can be present to enable change of one or multiple different tools; For example, the tool changer 260 can permit changing one tool with the same tool for the purpose of replacing a worn tool of the same type, or a different tool with the purpose to impart a different functionality in the deposited layer during the deposition process can be changed. A tool changer 260 is optional and may be omitted if desired. The tool changer 260 can comprise a variety of tools disposed in dormant positions (e.g., waiting to be used) and can comprise a mechanism for automatically or manually positioning a selected tool into an active position (e.g., where the tool can actively be used). For example, different tools can be used to deposit a first track and additional tracks on the first track. Alternatively, different tools can be used to deposit different shapes or geometries onto the substrate.

The SSA manufacturing systems described herein advantageously use tool or tooling which is non-consumable and is configured to deposit the feedstock material onto a substrate. The tool or tooling can be configured to exert frictional and other forces on the feedstock material for imparting rotation to the feedstock material from the body of the tool when rotated at a speed sufficient for imposing frictional heating of the feedstock material against a substrate. As described in more detail below, the tool generally comprises a body with a throat which is in communication with the feeding unit to receive material from the feeding unit. The body is designed to deposit the received ally feedstock material from the throat onto the substrate. The body can be configured with one or more surface features constructed and arranged to trap deposited feedstock material loaded on the substrate in a space or volume between the body and the substrate. The trapped material can be subjected to forming and/or shearing forces to deposit the feedstock material in solid form onto a surface of the substrate.

In certain embodiments, the tool or tooling can be produced using materials with a higher hardness than the feedstock material to be deposited and harder than the substrate. For example, the tool or tooling may comprise tool steel, copper and copper feedstock materials, tungsten or tungsten feedstock materials, and other metals which in pure or alloy form have a higher Vickers hardness than the alloy to be deposited and the substrate material. By selecting a higher hardness for the tooling material, the tooling generally is not consumed or deformed during the deposition process and can be used to provide multiple tracks on the substrate without the need to change the tool.

Various interior geometries for the tooling are possible. With a non-circular geometry, the consumable filler material can rotate at the same angular velocity as the non-consumable portion of the tool due to normal forces being exerted by the tool at the surface of the tool throat against the feedstock. Such geometries include a square through-hole and an elliptical through-hole as examples. In configurations where only exertion of tangential forces on the surface of the feedstock material material by the internal surface of the throat of the tool are desirable, the feed stock can rotate at a different angular velocity than the angular velocity of the tool. A circular geometry for the cross-section of the tool in combination with detached or loosely attached feedstock can result in the deposit material and tool rotating at the same or different velocities. Illustrations of various tool geometries and surface features on the tool are described in more detail below.

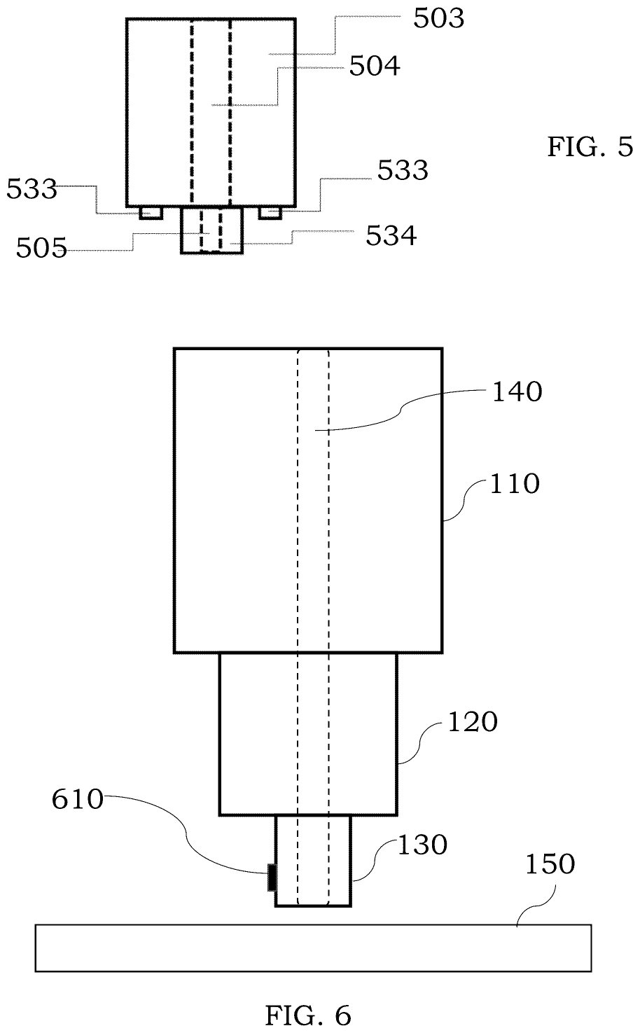

In certain embodiments, a tool can include a shoulder or other geometric features on a surface to assist in depositing the feedstock material material in solid for on a surface of a substrate. For example and referring to FIG. 5, a tool 503 with a throat 504 is shown. A pin 534 with a throat 505 extends from a tool shoulder, where the pin throat 505 is in communication with the tool throat 504. A pin 534 is an optional component of the solid-state additive manufacturing additive manufacturing system. The pin 534 can enable better stirring of the surface region of the workpiece and the feedstock material material. The tool shoulder facing the substrate can include at least one nub 533 made of the same or different material as the tool material. The geometry structures on the tool shoulder may be nubs having various shapes and located in various positions of the tool shoulder for enhancing mechanical stirring of the deposited feedstock material. If desired, the nub 533 can be replaceable by an end user, so the nubs can be replaced without needing to replace the entire tool 503. The tool 503 can include one, two, three, four, five, six or more nubs. The nubs can be arranged in a symmetric or asymmetric pattern as desired. The nubs can be solid or hollow and different nubs on a tool may have different shapes, heights, etc. Various tool components are described, for example, in commonly owned U.S. Pat. No. 11,311,959, the entire disclosure of which is incorporated herein by reference. As discussed below, the tool 503 can include internal passageways to facilitate heat removal and/or heat control of the tool 503.

In certain embodiments, the throat of the spindles and tools described herein may have different lengths, shapes and geometries as desired. For example, the cross-sectional shape of the throat may be square, rectangular, circular, elliptical, oval or other shapes. Further, the cross-sectional shape, diameter, etc. need not be the same from a top edge of the tool to a bottom edge of the tool. The diameter can increase or decrease toward the surface of the tool to be placed adjacent to the substrate.

While not shown the system can also include other suitable components including, but not limited to, gas supplies, external energy sources, ovens, thermocouples, motors, platforms, etc. In certain embodiments, the tool can include, or can be configured to receive, a temperature sensor as shown in FIG. 6. The tool 130 can include a temperature sensor 610, which can be integral to the tool or added separately to the tool 130 and may be present on an external surface of the tool 130 or an internal surface of the tool 130. The sensor 610 can be designed to indirectly monitor the temperature at the surface of the substrate 150 during deposition of the feedstock material onto a surface of the substrate. Since it is often difficult to measure the temperature directly at the surface of the substrate 150 during deposition, the temperature sensor 610 can be placed a suitable distance above the surface. As noted in more detail below, a selected temperature window can be used to deposit feedstock material, that after heat treatment, has desirable physical and/or mechanical properties. The temperature sensor 610 can include a thermometer, a thermocouple, a resistive temperature measuring device, an optical device, an infrared sensor, a bimetallic device, a change-of-state sensor or other devices which can measure or sense temperature. The sensor 610 can be coupled to the other components in a wired or wireless manner to transmit temperature information to the system. While the exact positioning of the sensor 610 may vary, the sensor 610 is typically located about 0.3 mm to about 0.5 mm above a surface of the substrate 150. The temperature values described herein for producing parts having certain properties refers to the temperature values measured using a sensor similar to the sensor 610 and not necessarily the actual temperature at the interface between the tool 130 and the surface of the substrate 150. The tool temperature can be monitored and selecting, based on measurements from the sensor 610, to deposit the feedstock material within a selected tool temperature range.

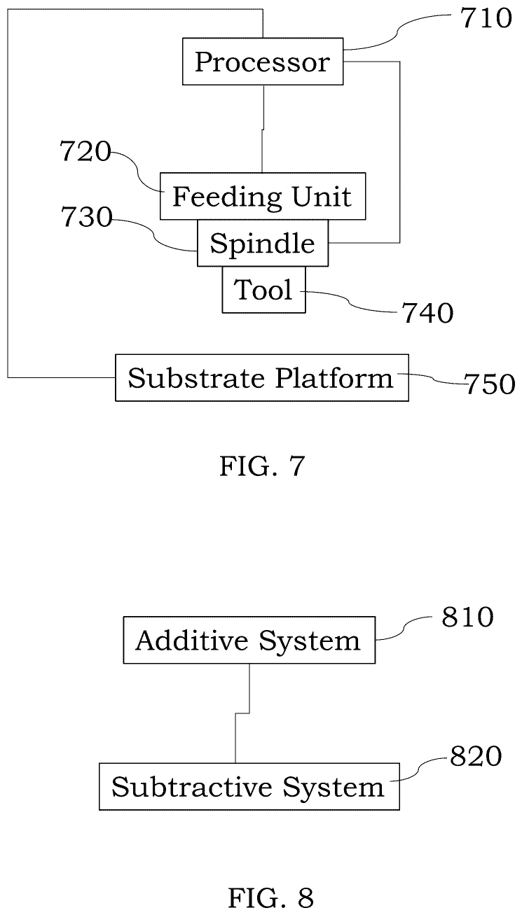

In certain configurations, the various components of the SSA manufacturing system are typically under control using a processor and one or more application software programs. For example and referring to FIG. 7, a block diagram of certain components is shown which can be controlled by a processor of a computer system or a dedicated processor. The system 700 includes a processor 710 electrically coupled to the feeding unit 720, the spindle 730, temperature control devices 740 and a platform 750 configured to receive a substrate. The processor 710 can optionally be coupled to the tool 740 and may also be electrically coupled to a temperature sensor (not shown) with the tool 740. The processor 710 can control one or more of feeding of the feedstock material through the feeding unit 720, rotational speed of the spindle 730 to maintain a temperature setpoint, varying the spindle torque to maintain a temperature setpoint, varying the spindle power to maintain a temperature setpoint, varying the deposition rate to maintain a temperature setpoint, varying the tool traverse rate to maintain a temperature setpoint, varying the feedstock material material feed rate to maintain a temperature setpoint, varying the layer height to maintain a temperature setpoint, varying the feedstock material force to maintain a temperature setpoint, varying pressure under the tool 740 to maintain a temperature setpoint, maintaining a temperature setpoint through an external heating source in, around, or near the tool 740, maintaining a temperature setpoint by a source of heat under or around the material being deposited and/or under or around the platform 750, and/or maintaining a temperature setpoint by varying the tool geometry in-situ during production. The processor 710 can also translate the substrate platform 750 to alter its position in the x-,y- or z-dimensions independently of movement of the spindle 730 and/or the tool 740. In a typical use, the substrate platform 750 is moved independently of any movement of the tool 740 during deposition of the feedstock material material onto the substrate platform 750.

The SSA manufacturing system also typically includes a memory unit, storage or other electrical components. The processor 710 can be used, in combination with one or more sensors present in the system to control the various components of the system. Such processes may be performed automatically by the processor without the need for user intervention or a user may enter parameters through a user interface. In certain configurations, the processor may be present in one or more computer systems and/or common hardware circuity including, for example, a microprocessor and/or suitable software for operating the system. The processor can be integral to the systems or may be present on one or more accessory boards, printed circuit boards or computers electrically coupled to the components of the system. The processor is typically electrically coupled to one or more memory units to receive data from the other components of the system and permit adjustment of the various system parameters and/or control the system components as needed or desired. The processor may be part of a general-purpose computer such as those based on Unix, Intel PENTIUM-type processor, Intel Core™ processors, Intel Xeon™ processors, AMD Ryzen™ processors, AMD Athlon™ processors, AMD FX™ processors, Motorola PowerPC, Sun UltraSPARC, Hewlett-Packard PA-RISC processors, Apple-designed processors including Apple A12 processor, Apple A11 processor and others or any other type of processor. One or more of any type computer system may be used according to various embodiments of the technology. Further, the system may be connected to a single computer or may be distributed among a plurality of computers attached by a communications network. It should be appreciated that other functions, including network communication, can be performed and the technology is not limited to having any particular function or set of functions. Various aspects may be implemented as specialized software executing in a general-purpose computer system. The computer system may include a processor connected to one or more memory devices, such as a disk drive, memory, or other device for storing data. Memory is typically used for storing programs, authorized users, etc. during operation of the system. Components of the computer system may be coupled by an interconnection device, which may include one or more buses (e.g., between components that are integrated within a same machine) and/or a network (e.g., between components that reside on separate discrete machines). The interconnection device provides for communications (e.g., signals, data, instructions) to be exchanged between components of the system. The computer system typically can receive and/or issue commands within a processing time, e.g., a few milliseconds, a few microseconds or less, to permit rapid control of the system. For example, computer control can be implemented to control the temperature during deposition of the feedstock material on the surface of the substrate. The processor typically is electrically coupled to a power source which can, for example, be a direct current source, an alternating current source, a battery, a fuel cell or other power sources or combinations of power sources. The power source can be shared by the other components of the system. The system may also include one or more input devices, for example, a keyboard, mouse, trackball, microphone, touch screen, manual switch (e.g., override switch) and one or more output devices, for example, a printing device, display screen, lights, speaker. The system may contain one or more communication interfaces that connect the computer system to a communication network (in addition or as an alternative to the interconnection device). The system may also include suitable circuitry to convert signals received from the various electrical devices present in the system. Such circuitry can be present on a printed circuit board or may be present on a separate board or device that is electrically coupled to the printed circuit board through a suitable interface, e.g., a serial ATA interface, ISA interface, PCI interface, a USB interface, a Fibre Channel interface, a Firewire interface, a M.2 connector interface, a PCIE interface, a mSATA interface or the like or through one or more wireless interfaces, e.g., Bluetooth, Wi-Fi, Near Field Communication or other wireless protocols and/or interfaces.

In certain embodiments, the system typically comprises a storage system which can be removable and/or can include a non-transitory computer readable medium. The storage system typically includes a computer readable and writeable nonvolatile recording medium in which codes of software can be stored that can be used by a program to be executed by the processor or information stored on or in the medium to be processed by the program. The medium may, for example, be a hard disk, solid state drive or flash memory. The program or instructions to be executed by the processor may be located locally or remotely and can be retrieved by the processor by way of an interconnection mechanism, a communication network or other means as desired. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in the storage system or in the memory system. The processor generally manipulates the data within the integrated circuit memory and then copies the data to the medium after processing is completed. A variety of mechanisms are known for managing data movement between the medium and the integrated circuit memory element and the technology is not limited thereto. The technology is also not limited to a particular memory system or storage system. In certain embodiments, the system may also include specially-programmed, special-purpose hardware, for example, an application-specific integrated circuit (ASIC), microprocessor units MPU) or a field programmable gate array (FPGA) or combinations thereof. Aspects of the technology may be implemented in software, hardware or firmware, or any combination thereof. Further, such methods, acts, systems, system elements and components thereof may be implemented as part of the systems described above or as an independent component. Although specific systems are described by way of example as one type of system upon which various aspects of the technology may be practiced, it should be appreciated that aspects are not limited to being implemented on the described system. Various aspects may be practiced on one or more systems having a different architecture or components. The system may comprise a general-purpose computer system that is programmable using a high-level computer programming language. The systems may be also implemented using specially programmed, special purpose hardware. In the systems, the processor is typically a commercially available processor such as the well-known microprocessors available from Intel, AMD, Apple and others. Many other processors are also commercially available. Such a processor usually executes an operating system which may be, for example, the Windows 7, Windows 8 or Windows 10 operating systems available from the Microsoft Corporation, MAC OS X, e.g., Snow Leopard, Lion, Mountain Lion, Mojave, High Sierra, El Capitan or other versions available from Apple, the Solaris operating system available from Sun Microsystems, or UNIX or Linux operating systems available from various sources. Many other operating systems may be used, and in certain embodiments a simple set of commands or instructions may function as the operating system. Further, the processor can be designed as a quantum processor designed to perform one or more functions using one or more qubits. In some instances, a simple set of commands may be present on the computer system, a table or a mobile device that can communicate with the components of the SSA system and can be updated from time to time using one or more wireless or wired connections between the control device and the SSA system.

In certain examples, the processor and operating system may together define a platform for which application programs in high-level programming languages may be written. It should be understood that the technology is not limited to a particular system platform, processor, operating system, or network. Also, it should be apparent to those skilled in the art, given the benefit of this disclosure, that the present technology is not limited to a specific programming language or computer system. Further, it should be appreciated that other appropriate programming languages and other appropriate systems could also be used. In certain examples, the hardware or software can be configured to implement cognitive architecture, neural networks or other suitable implementations. If desired, one or more portions of the computer system may be distributed across one or more computer systems coupled to a communications network. These computer systems also may be general-purpose computer systems. For example, various aspects may be distributed among one or more computer systems configured to provide a service (e.g., servers) to one or more client computers, or to perform an overall task as part of a distributed system. For example, various aspects may be performed on a client-server or multi-tier system that includes components distributed among one or more server systems that perform various functions according to various embodiments. These components may be executable, intermediate (e.g., IL) or interpreted (e.g., Java) code which communicate over a communication network (e.g., the Internet) using a communication protocol (e.g., TCP/IP). It should also be appreciated that the technology is not limited to executing on any particular system or group of systems. Also, it should be appreciated that the technology is not limited to any particular distributed architecture, network, or communication protocol.

In some instances, various embodiments may be programmed using an object-oriented programming language, such as, for example, SQL, SmallTalk, Basic, Java, Javascript, PHP, C++, Ada, Python, iOS/Swift, Ruby on Rails or C# (C-Sharp). Other object-oriented programming languages may also be used. Alternatively, functional, scripting, and/or logical programming languages may be used. Various configurations may be implemented in a non-programmed environment (e.g., documents created in HTML, XML or other format that, when viewed in a window of a browser program, render aspects of a graphical- user interface (GUI) or perform other functions). Certain configurations may be implemented as programmed or non-programmed elements, or any combination thereof. In some instances, the system may comprise a software interface on the SSA system that can receive user input and parameters from a user based on the particular feedstock material to be deposited. Instructions and other information and parameters can be entered on SSA system directly through the user interface or indirectly through an interface of an associated mobile device, e.g., tablet, phone, etc., that communicates with the SSA system over a wireless or wired network. The instructions stored in the memory can execute a software module or control routine for the system, which in effect can provide a controllable model of the system to permit deposition of the feedstock material in a desired manner.

In certain embodiments, the system can include one or more communications interfaces to permit the SSA system to communicate with other systems or components of the SSA system. For example, the system can include an antenna that may be one or more of a Bluetooth antenna, a cellular antenna, a radio antenna, other antennas or combinations thereof.

In some embodiments, the system can include subtractive components in addition to additive components. For example and referring to FIG. 8, a system can include an additive system 810 and a subtractive system 820. The additive system 810 can be configured as described herein, e.g., to add material in solid form to a surface of the substrate. The exact nature of the operations provided by the subtractive system 820 can vary. For example, the subtractive system 820 can be configured to provide one or more of grinding, sanding, milling, etc. to remove some of the material which was added to the substrate using the additive system 810. The subtractive system 820 can be used to drill holes or apertures or otherwise machine the final product produced using the additive system 810 into a final part.

### Processes and Process Parameters

As noted herein, a SSA manufacturing system can be used to convert/print the feedstock material feedstock into larger or different parts. Without wishing to be bound by any one system, configuration, heat is generated by friction between the tool and the substrate (and in certain cases, if the pin extends from the tool shoulder, the friction is caused by the pin passing through the substrate surface zone). The generated heat provides a significant amount of plastic deformation in the vicinity of the rotating tool (and/or rotating pin, if used). A substantial strain is imparted to the substrate resulting in refinement of its micro-structure. The substrate material adjacent to the tool softens and the softened material is mechanically-stirred, and at the same time, mixed and joined with the feedstock material material added via the passageway of the tool using mechanical pressure supplied by the tool shoulder.

In certain configurations, the process can control deposition temperature, i.e. temperature at the interface between the feedstock material and either substrate or previously deposited layers by simultaneously controlling key system parameters such as force, pressure, rotation, external heating, external cooling, preheating of substrate, gas flow, ambient temperature, traverse speed, deposition rate, etc. It can be difficult to measure the exact temperature at the feedstock tip that interfaces with the substrate and/or previously deposited material. As in indirect measure or temperature, thermocouples (or other temperature sensing devices) can be located in the tool approximately 0.35 mm above the tip of the tool and filler material. Locating the temperature sensors at other locations might produce different biases versus the actual temperature at the feedstock tip. For example, a smaller gap between feedstock tip and the thermocouple, would be expected to give higher temperature readings for the same actual deposition temperature. Alternatively, laser temperature sensing or other temperature sensing devices could be used instead.

In certain configurations, the exact thickness of any one track may vary from about 0.03 inches to about 0.2 inches, more particularly about 0.04 inches to about 0.18 inches, e.g., 0.05 inches, 0.06 inches, 0.07 inches, 0.08 inches, 0.09 inches, 0.10 inches, 0.11 inches, 0.12 inches, 0.13 inches, 0.14 inches, 0.15 inches, 0.16 inches, or 0.17 inches. Additional tracks can each have a similar thickness as the single track. For example, the thickness of each additional track can vary from about 0.03 inches to about 0.2 inches, more particularly about 0.04 inches to about 0.18 inches, e.g., 0.05 inches, 0.06 inches, 0.07 inches, 0.08 inches, 0.09 inches, 0.10 inches, 0.11 inches, 0.12 inches, 0.13 inches, 0.14 inches, 0.15 inches, 0.16 inches, or 0.17 inches. The percentage of overlap between different tracks may vary from about 5% overlap to about 50% overlap in the x-y direction. For example, adjacent tracks can overlap about 10% to about 40% in the x-y direction, e.g., adjacent tracks can overlap 15%, 20%, 25%, 30%, or 35% in the x-y direction.

In certain embodiments, the temperature control may be accomplished by varying parameters of the system in combination with the internal passageways of the tool. For example, in addition to using a cooling fluid within the tool, one or more of the following parameters can be varied to control the temperature: varying the spindle speed to maintain a temperature setpoint, varying the spindle torque to maintain a temperature setpoint, varying the spindle power to maintain a temperature setpoint, varying the deposition rate to maintain a temperature setpoint, varying the tool traverse rate to maintain a temperature setpoint, varying the filler bar feed rate to maintain a temperature setpoint, varying the layer height to maintain a temperature setpoint, varying the filler bar force to maintain a temperature setpoint. varying the pressure under the tool to maintain a temperature setpoint, maintaining a temperature setpoint through an external heating source in, around, or near the tool, maintaining a temperature setpoint by a source of heat under or around the material being deposited, and/or maintaining a temperature setpoint by varying the tool geometry in-situ (during production). Without wishing to be bound by any particular theory, by selecting a suitable temperature range, the overall properties of the deposited feedstock material can be improved.

In some instances, the temperature can also be controlled, at least in part, by selecting or altering spindle speed during deposition. For example, the spindle can be rotated from 150 rpm to about 350 rpm depending on how fast the tooling is moving in the x-y direction. In some examples, spindle rotation rate may vary from about 100 rpm to about 800 rpm, more particularly about 200 rpm to about 700 rpm or 250 rpm to 600 rpm. The tooling is coupled to the spindle and generally rotates at the same rpm as the spindle. The spindle speed can vary with startup speeds typically being higher than deposition speeds. For example, spindle speed may be 500-600 rpm during startup to increase the surface temperature and then reduced to 180-300 rpm during deposition to assist in maintaining a desired deposition temperature. Alternatively, spindle speed may be constant and fluid of different temperatures can be introduced into the tool to control the tool temperature during use.

In certain embodiments, the exact feed rate of the feedstock material may vary from about 1 inch per minute to about 6 inches per minute, more particularly about 1.5 inches per minute to 3.5 inches per minute, e.g., 1.6 inches per minute, 1.7 inches per minute, 1.8 inches per minute, 1.9 inches per minute, 2.0 inches per minute, 2.1 inches per minute, 2.2 inches per minute, 2.3 inches per minute, 2.4 inches per minute, 2.5 inches per minute, 2.6 inches per minute, 2.7 inches per minute, 2.8 inches per minute, 2.9 inches per minute, or 3.0 inches per minute. The feed rate can be the same or different when depositing single tracks or single walls and overlapping walls. For example, it may be desirable to increase the feed rate during addition of overlapping tracks to increase the temperature at the surface The feed rate can be increased or decreased based on the temperature measurements to maintain a suitable temperature range during the addition process.

In some embodiments, the feedstock material can be coated or sprayed with a lubricant or other material suitable for depositing the feedstock material on the substrate. In general, the lubricant can assist in movement of the feedstock material through the hollow passageway of the tooling. Suitable lubricant materials include, but are not limited to, graphite, carbon black, and other forms of carbon. If desired, a metal lubricant can also be used alone or with the carbon based lubricant material. During the addition of the feedstock material, the lubricant coating tends to be pushed toward the outside of the deposited material and can be subsequently removed during the heat treating of the deposited feedstock material. In other issues, the feedstock material used may be lubricant free.

In some configurations, the tooling can be moved horizontally at a desired rate to deposit a desired amount of information onto the substrate. The exact horizontal movement rate may vary from about 1 inch per minute to about 10 inches per minute, more particularly about 3 inches per minute to about 7 inches per minute, e.g., about 3.5 inches per minute, 4 inches per minute, 4.5 inches per minute, 5 inches per minute, 5.5 inches per minute, inches per minute or 6.5 inches per minute.

In certain examples, the substrate can be cleaned or treated prior to deposition of the material onto the substrate material. For example, a surface of the substrate can be subjected to machining, sanding, polishing, etching, chemical or physical treatment or other processes to clean the surface of the substrate or alter the surface of the substrate if desired.

In certain configurations, one or more subtractive processes can be performed on the formed product. For example, a portion of the added feedstock material layer can be removed using a subtractive process to provide a subtracted layer on the substrate. The resulting subtracted layer can be subjected to heat treatment. Additional layers of material can then be added on the heat treated layer or multiple layers can be added prior to any heat treatment occurring.

In some examples, the final formed layers or tracks can be subjected to post addition treatment including solution treatment, heating or the like. For example, the resulting aluminum alloy can be tempered using similar methods and process conditions commonly used to temper certain aluminum alloys, e.g., 7075, 7050, 6000 series, 5000 series aluminum, titanium alloys, etc.

### Tools

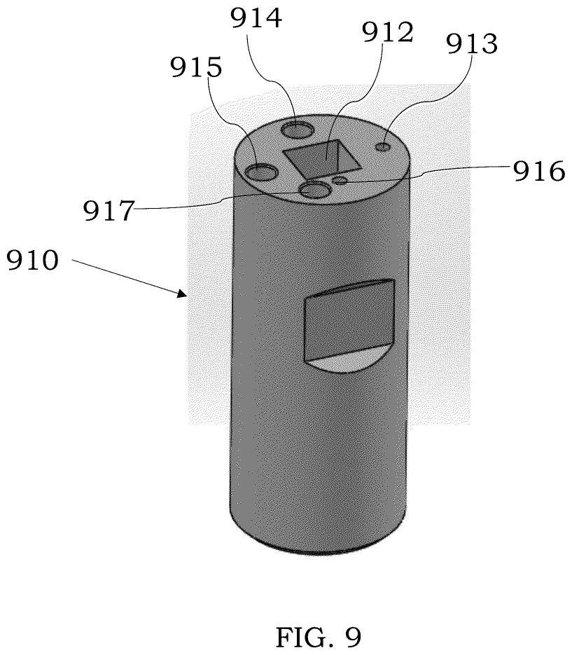

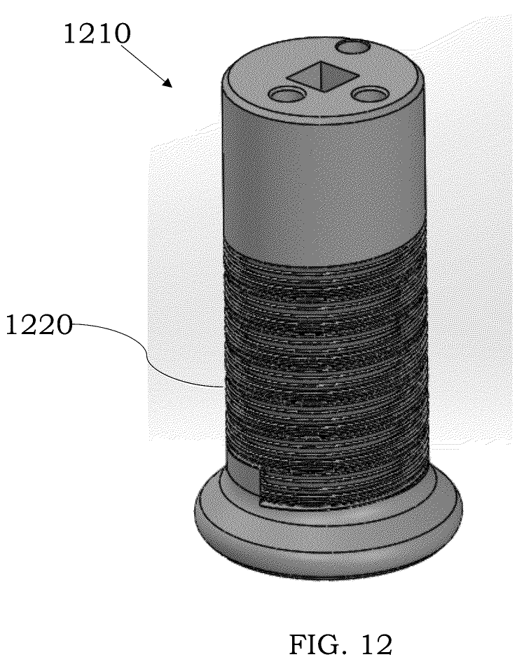

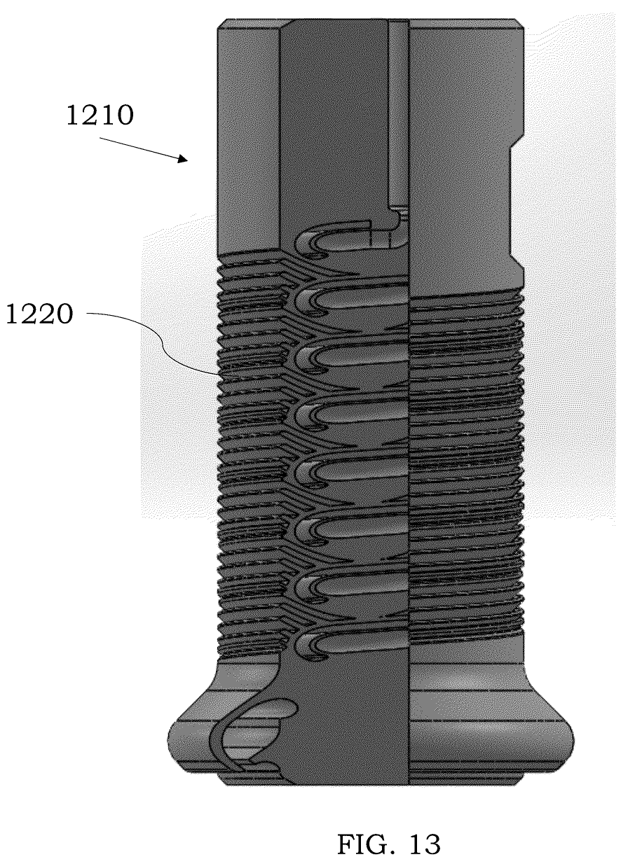

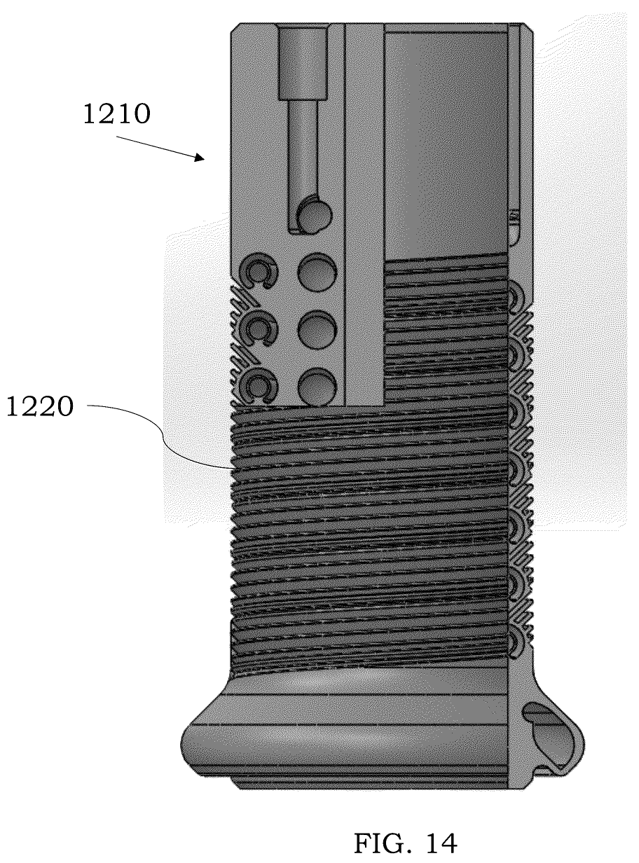

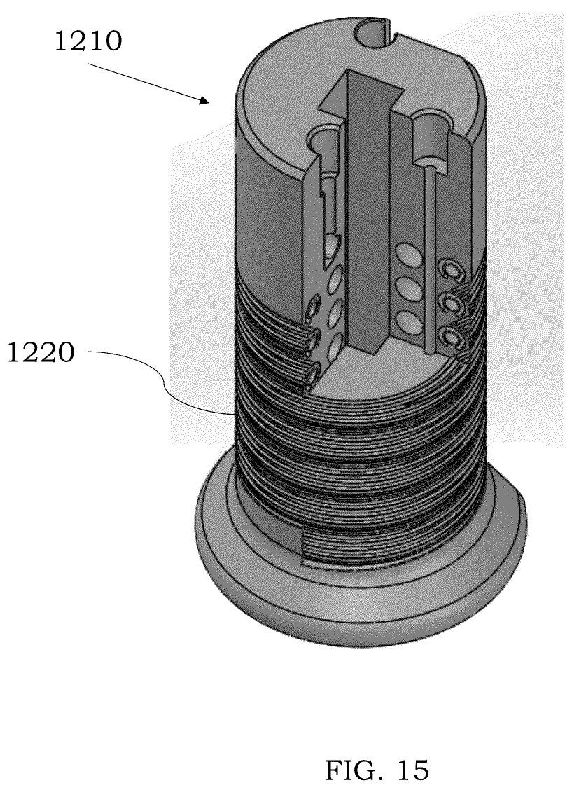

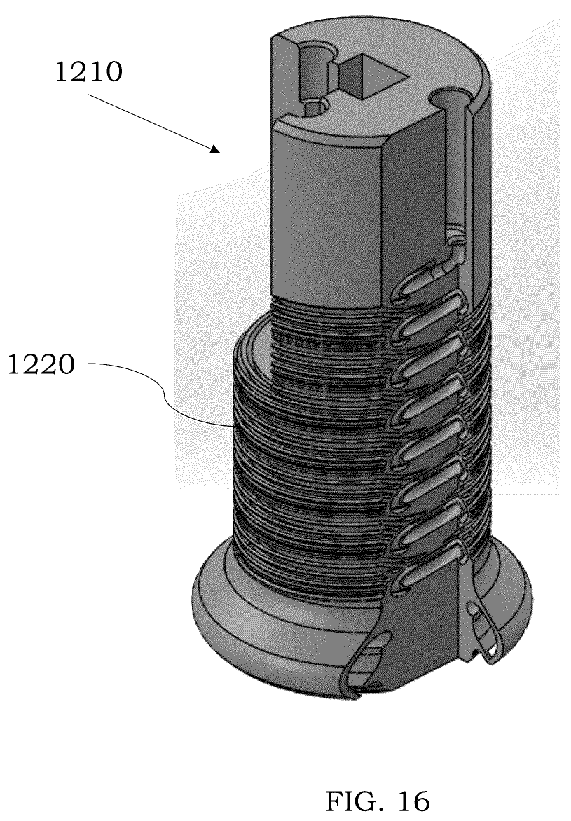

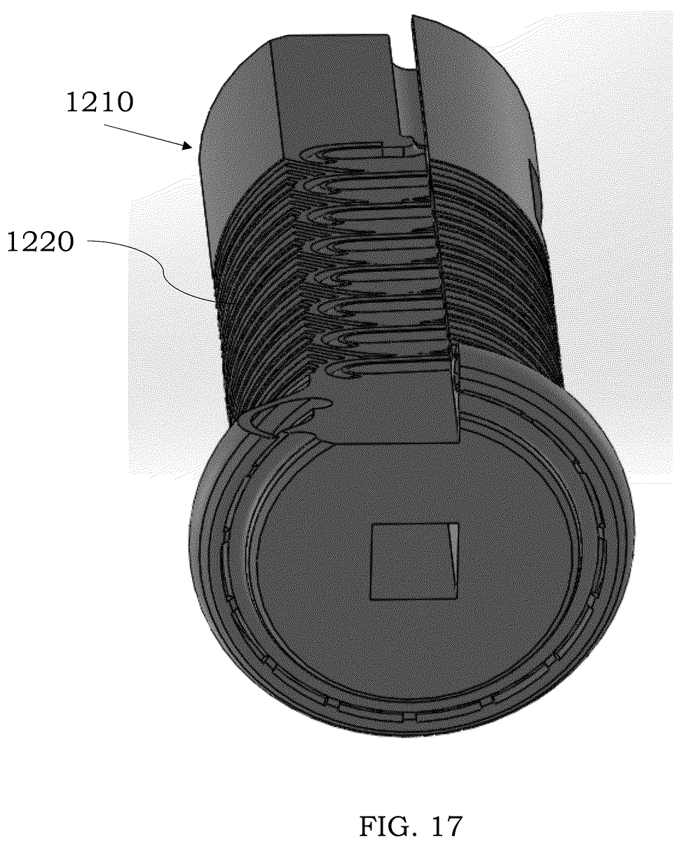

Several configurations of a tool are shown in FIGS. 9-17. FIG. 9 shows a perspective view of a tool 910 having internal passageways or channels (see FIGS. 12-17). A central channel 912 (shown as square though other channel shapes including circular, round, elliptical, triangular, etc. can be used if desired) is designed to receive a feedstock or filler material from a material delivery system as noted herein. The circular holes 913, 914, 915, 916 and 917 shown in the top can be used to couple the tool 910 to another component of the system and/or introduce a cooling fluid into the tool 910. Solid filler material can be introduced into the central channel 912 and used to add a solid layer onto a substrate.

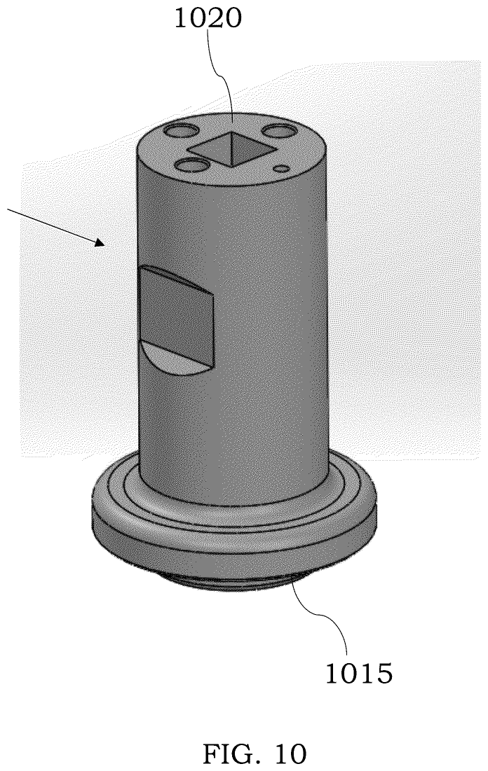

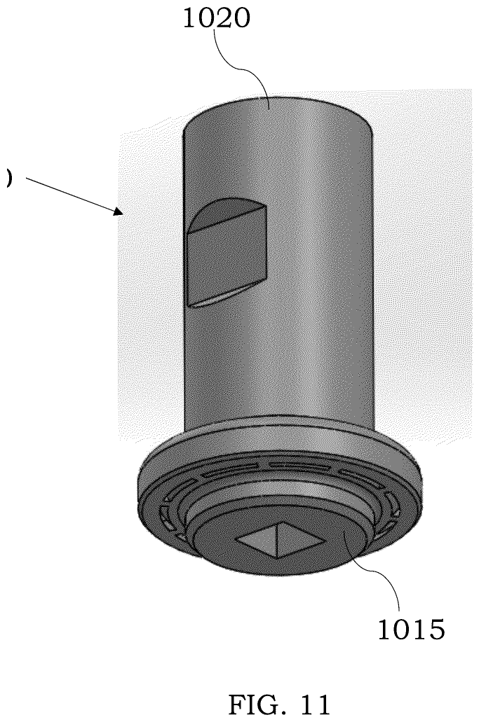

FIGS. 10 and 11 show another tool configuration where one end 1015 of the tool 1010 has a larger diameter than another end 1020 of the tool 1010. If desired, the internal passageways may be present in all areas of the tool 1010 or only at the areas of the tool 1010 that include a larger diameter, e.g., toward end 1015.

In certain embodiments, the tool of FIGS. 12-17 includes internal cooling, heat exchange fins and gas shielding features. Cutaway views of the tool are shown in particular showing the various internal features of the tool 1210. While the internal passageways are shown as being continuous in some figures, multiple independent and separate internal passageways can be used if desired. The internal passageways (collectively 1220) are shown as being non-longitudinally arranged, with respect to a long axis of the tool 1210. For example, the passageways 1220 may run radially from an outside edge of the tool toward the interior to facilitate heat removal or heat control from the tool 1210. The radial direction may be parallel to a radial direction of the tool body or may be angled with respect to the radial direction of the tool body. The internal passageways may be non-linear from end to end of the tool 1210. In some embodiments, a longitudinal channel can be connected to radial arms or extensions that radiate out into the tool body. A cooling fluid introduced into the longitudinal channel can also flow through the radial arms to permit cooling and/or temperature control of the tool 1210. The internal diameter of the internal passageways or channels may be the same or may differ at different areas of the passageways or channels. Further, the cross-sectional geometries of the passageways 1220 can be different at different areas of the internal passageways or channels.

In some embodiments, the internal passageways can include a coating of material in certain areas to facilitate heat removal at those areas. For example, thermally conductive metals and/or polymers may be present on internal surfaces of the internal passageways to facilitate heat removal/transfer.

The tooling described herein is typically used in a solid state additive system as described in more detail herein and can also be used in subtractive processes as well. In certain embodiments, the tool comprises a 1-piece body. In other embodiments, the tool comprises one or more heat exchange structures as noted herein. In some configurations, the heat exchange structures are internal heat exchange fins or external heat exchange fins. Both internal and external heat exchange fins can also be present. The body of the tool may comprises various materials including, for example, tool steel, copper, a copper alloy, tungsten, a tungsten alloy and combinations thereof.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A solid state manufacturing tool comprising one or more internal passageways configured to cool the solid state manufacturing tool during use.

2. The solid state manufacturing tool of claim 1, wherein the tool comprises a 1-piece body.

3. The solid state manufacturing tool of claim 1, wherein the tool comprises one or more heat exchange structures.

4. The solid state manufacturing tool of claim 3, wherein the heat exchange structures are internal heat exchange fins.

5. The solid state manufacturing tool of claim 3, wherein the heat exchange structures are external heat exchange fins.

6. The solid state manufacturing tool of claim 4, wherein the heat exchange structures further comprise external heat exchange fins.

7. The solid state manufacturing tool of claim 1, wherein a tool body comprises tool steel, copper, a copper alloy, tungsten or a tungsten alloy.

8. The solid state manufacturing tool of claim 1, wherein at least one internal passageway comprises a non-linear shape.

9. The solid state manufacturing tool of claim 1, wherein at least one internal passageway is arranged in a non-longitudinal manner relative to a longitudinal direction of the tool body.

10. The solid state manufacturing tool of claim 9, wherein the at least one internal passageway is arranged radially.

11. An additive manufacturing system comprising:
a feeding unit configured to receive a filler material;
a spindle comprising an internal path configured to receive the filler material from the feeding unit;
a tool coupled to the spindle and configured to receive the filler material from the spindle and add the received filler material to a surface of a substrate in a solid state, wherein the tool comprises the solid state manufacturing tool of claim 1;
a temperature sensor configured to measure a temperature of the solid state manufacturing tool during addition of the filler material to the surface of the workpiece;
a processor electrically coupled to the temperature sensor and the spindle; and
a computer readable medium electrically coupled to the processor, wherein the computer readable medium has instructions stored thereon, wherein the instructions, when executed by the processor, cause the processor to control movement of the spindle during addition of the filler material to the surface of the substrate.

12. The additive manufacturing system of claim 11, wherein the processor is configured to increase a temperature of the tool from a first tool temperature to a second tool temperature that is the same as or greater than the first tool temperature.

13. The additive manufacturing system of claim 11, wherein the tool comprises tool steel, copper, a copper alloy, tungsten or a tungsten alloy.

14. The additive manufacturing system of claim 11, wherein the tool comprises at least one nub.

15. The additive manufacturing system of claim 11, wherein the feeding unit comprises an actuator to force the filler material into the spindle and the tool.

16. A subtractive and additive method comprising:
adding a solid material as a first layer to a surface of a substrate using an additive manufacturing process comprising the tool of claim 1, wherein the solid material is added to the surface of the workpiece in a solid state at a first tool temperature; and
removing a portion of the added solid layer using a subtractive process to provide a subtracted, first solid layer on the substrate.

17. The method of claim 16, wherein a first tool temperature of the tool is at least 350 degrees Celsius.

18. The method of claim 17, further comprising adding a second solid layer in the solid state to the subtracted, first solid layer using the tool, wherein the second solid layer is added using a second tool temperature that is the same as the first tool temperature.

19. The method of claim 17, further comprising adding a second solid layer in the solid state to the subtracted, first solid layer using the tool, wherein the second solid layer is added using a second tool temperature that is greater than the first tool temperature.

20. The method of claim 17, wherein the first tool temperature is maintained using the internal passageways of the tool and by one or more of:
varying a speed of a spindle coupled to the tool; or
varying torque of the spindle coupled to the tool; or
varying power of the spindle coupled to the tool; or
varying a deposition rate of the added solid material; or
varying a traverse rate of the tool; or
varying a filler feed rate into the tool; or
varying a layer height; or
varying a filler force; or
varying a pressure under the tool; or
using an external heating/cooling source adjacent to the tool; or
using an external heating/cooling source adjacent to the surface of the substrate; or
varying a tool geometry during addition.
